(19) United States
(12) Patent Application Publication
(10) Pub. No.: US 2026/0163185 A1
(43) Pub. Date: Jun. 11, 2026

(54) POWER STORAGE DEVICE

(71) Applicant: TOYOTA JIDOSHA KABUSHIKI KAISHA, Toyota-shi (JP)

(72) Inventors: Shigeyuki INOUE, Toyota-shi (JP); Keiji Kaita, Miyoshi-shi (JP)

(73) Assignee: TOYOTA JIDOSHA KABUSHIKI KAISHA, Toyota-shi (JP)

(21) Appl. No.: 19/180,575

(22) Filed: Apr. 16, 2025

(30) Foreign Application Priority Data
May 16, 2024 (JP) 2024-080007

(51) Int. Cl. H01M 50/474; B60L 50/64; H01M 10/658; H01M 50/477

(52) U.S. Cl. CPC H01M 50/474; H01M 10/658; H01M 50/477; B60L 50/64; H01M 2220/20

(57) ABSTRACT

A power storage device includes: at least one power storage cell having a lower surface provided with a safety valve; a lower case including a bottom surface located below the at least one power storage cell; a structural member fixed to the lower case; a spacer member fixed to the structural member to provide a space together with the bottom surface of the lower case; and a fastening member that fastens the spacer member to the structural member. The spacer member has a through hole provided below the safety valve.

### CROSS REFERENCE TO RELATED APPLICATIONS

This nonprovisional application is based on Japanese Patent Application No. 2024-080007 filed on May 16, 2024 with the Japan Patent Office, the entire contents of which are hereby incorporated by reference.

### BACKGROUND

### Field

The present disclosure relates to a power storage device.

### Description of the Background Art

For example, Japanese National Patent Publication No. 2024-502583 discloses a battery pack including: a battery stack; a tray that accommodates the battery stack; and an adhesive for a bottom structure, the adhesive being provided between the tray and the battery stack.

### SUMMARY

The battery pack as disclosed in Japanese National Patent Publication No. 2024-502583 includes a housing having a bottom portion that is more likely to receive external force from below. Thus, it is desirable that this bottom portion is replaceable.

An object of the present disclosure is to provide a power storage device having a bottom portion that can be replaced.

A power storage device according to one aspect of the present disclosure includes: at least one power storage cell having a lower surface provided with a safety valve; a lower case having a bottom surface located below the at least one power storage cell; a structural member fixed to the lower case; a spacer member fixed to the structural member to provide a space together with the bottom surface of the lower case; and a fastening member that fastens the spacer member to the structural member. The spacer member has a through hole provided below the safety valve.

A power storage device according to another aspect of the present disclosure includes: at least one power storage cell having a lower surface provided with a safety valve; a lower case having a bottom surface located below the at least one power storage cell; a panel member provided below the bottom surface of the lower case, a space being provided between the panel member and the bottom surface of the lower case; and a fastening member that fastens the panel member to the lower case. The bottom surface of the lower case has an opening provided below the safety valve.

The foregoing and other objects, features, aspects, and advantages of the present disclosure will become apparent from the following detailed description of the present disclosure when taken in conjunction with the accompanying drawings.

### BRIEF DESCRIPTION OF THE DRAWINGS

FIG. 1 is a diagram schematically showing a vehicle including a power storage device in one embodiment of the present disclosure.

FIG. 2 is a perspective view schematically showing the power storage device and a frame member.

FIG. 3 is a cross-sectional view taken along a line III-III in FIG. 2.

FIG. 4 is a cross-sectional view taken along a line IV-IV in FIG. 3.

FIG. 5 is a plan view schematically showing a cooler.

FIG. 6 is a cross-sectional view taken along a line VI-VI in FIG. 5.

FIG. 7 is a cross-sectional view schematically showing a modification of the power storage device.

### DESCRIPTION OF THE PREFERRED EMBODIMENTS

An embodiment of the present disclosure will be hereinafter described with reference to the accompanying drawings. In the drawings referred to below, the same or corresponding members are denoted by the same reference characters.

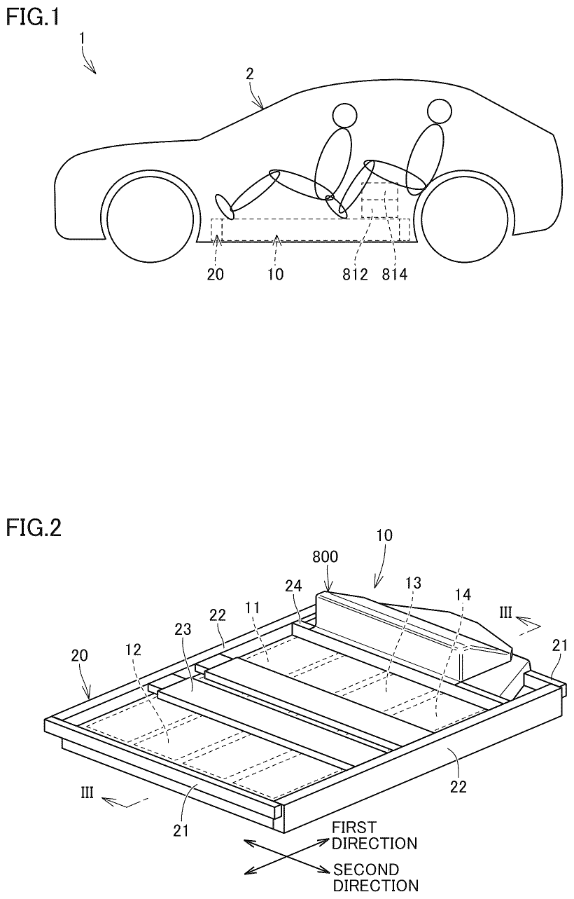

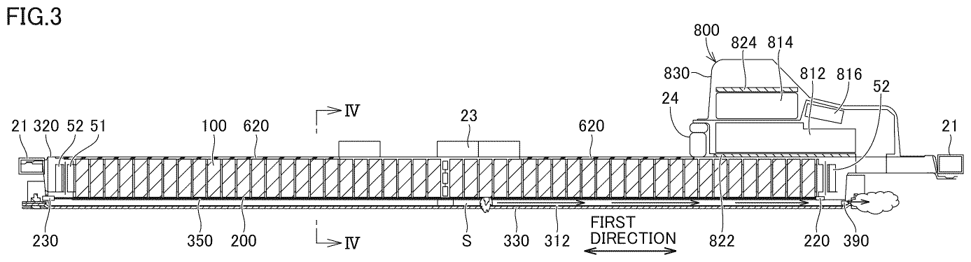

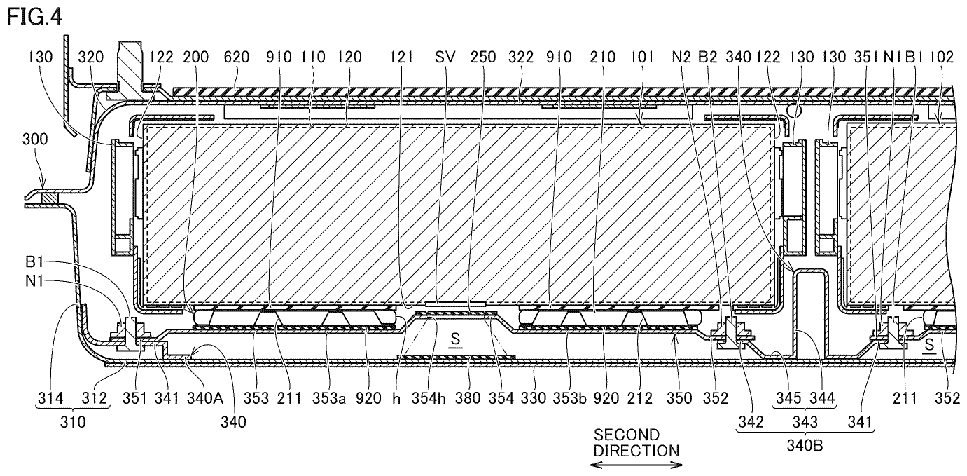

FIG. 1 is a diagram schematically showing a vehicle including a power storage device in one embodiment of the present disclosure. FIG. 2 is a perspective view schematically showing the power storage device and a frame member. FIG. 3 is a cross-sectional view taken along a line III-III in FIG. 2. FIG. 4 is a cross-sectional view taken along a line IV-IV in FIG. 3.

As shown in FIG. 1, a vehicle 1 includes a vehicle body 2 and a power storage device 10. Examples of vehicle 1 include a hybrid electric vehicle, a plug-in hybrid electric vehicle, and a battery electric vehicle.

As shown in FIGS. 1 and 2, vehicle body 2 includes a frame member 20. Frame member 20 is disposed on a bottom portion of vehicle body 2. Frame member 20 includes a pair of first frames 21, a pair of second frames 22, a first cross frame 23, and a second cross frame 24.

The pair of first frames 21 face each other in a first direction. Each first frame 21 is shaped to extend in a second direction orthogonal to both the first direction and an upward-downward direction. For example, the first direction may be parallel to a front-rear direction of vehicle 1, and the second direction may be parallel to a left-right direction (a width direction) of vehicle 1.

The pair of second frames 22 face each other in the second direction. Each second frame 22 is shaped to extend in the first direction. An end portion of each second frame 22 in the first direction is connected to first frame 21. The pair of second frames 22 are arranged in a substantially quadrangular cylindrical shape together with the pair of first frames 21 to surround power storage device 10.

First cross frame 23 is disposed between the pair of first frames 21 and couples the pair of second frames 22 to each other.

Second cross frame 24 is disposed between the pair of first frames 21 and couples the pair of second frames 22 to each other. Second cross frame 24 is spaced apart from first cross frame 23 in the first direction. Each of first cross frame 23 and second cross frame 24 forms, for example, a seat cross.

Power storage device 10 is attached to frame member 20. As shown in FIG. 2, power storage device 10 is disposed below first cross frame 23 and second cross frame 24. As shown in FIGS. 1 to 4, power storage device 10 includes four power storage stacks 11 to 14, a cooler 200, a housing 300, a reinforcement member 620, and a device unit 800. The number of power storage stacks is not limited to four.

Each of power storage stacks 11 to 14 includes at least one power storage cell 100. In the present embodiment, each of power storage stacks 11 to 14 includes a plurality of (for example, fifty) power storage cells 100 arranged side by side in the first direction. Each of power storage stacks 11 to 14 is formed in a rectangular parallelepiped shape elongated in the first direction. As shown in FIG. 2, four power storage stacks 11 to 14 are arranged side by side in the second direction.

As shown in FIG. 3, a pair of end plates 51 that sandwich the plurality of power storage cells 100 from both sides in the first direction are provided on both sides of the plurality of power storage cells 100 in the first direction. A monitoring unit (smart battery management) 52 is disposed outside each end plate 51 in the first direction.

As shown in FIG. 4, each power storage cell 100 includes an electrode assembly 110, a cell case 120, and a pair of external terminals 130.

Electrode assembly 110 may be formed of a wound body implemented by winding a positive electrode sheet and a negative electrode sheet with a separator being interposed therebetween, or may be formed of a stacked body implemented by stacking a positive electrode sheet and a negative electrode sheet with a separator being interposed therebetween. Electrode assembly 110 is formed in a shape elongated in the second direction.

Cell case 120 accommodates electrode assembly 110. Cell case 120 is formed in a rectangular parallelepiped shape. Cell case 120 is made of metal such as aluminum. Cell case 120 includes a valve installation surface 121 and a terminal installation surface 122.

Valve installation surface 121 is provided with a safety valve SV. In the present embodiment, valve installation surface 121 is formed of a lower surface of cell case 120. In other words, safety valve SV is provided in the lower surface of cell case 120 in power storage cell 100. FIG. 4 shows two-dot chain lines indicating the discharge direction of the gas that may be discharged from safety valve SV.

External terminal 130 is provided on terminal installation surface 122. In the present embodiment, terminal installation surface 122 is formed of a side surface of cell case 120 in the second direction.

Each external terminal 130 is provided on terminal installation surface 122 (the side surface in the second direction in the present embodiment) of cell case 120. One of the pair of external terminals 130 is provided on terminal installation surface 122 on one side of cell case 120 in the second direction. The other of the pair of external terminals 130 is provided on terminal installation surface 122 on the other side of cell case 120 in the second direction.

Cooler 200 cools at least one power storage cell 100. In the present embodiment, cooler 200 cools each of power storage stacks 11 to 14. A cooling medium (oil or the like) flows through cooler 200.

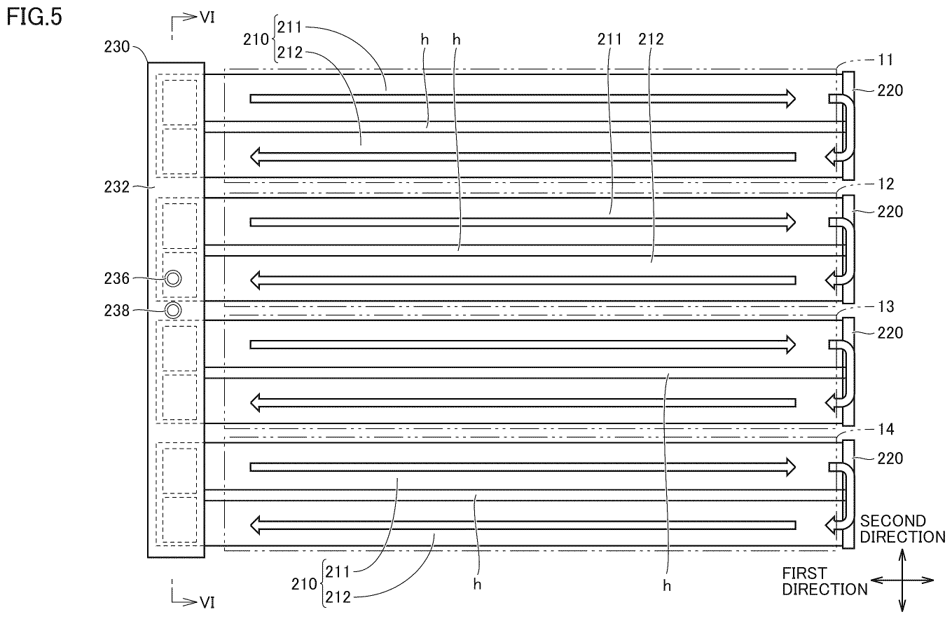

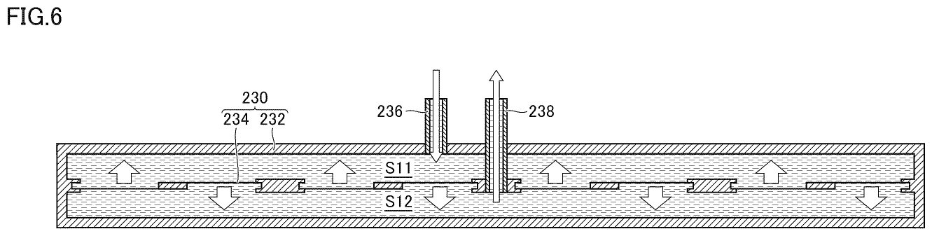

FIG. 5 is a plan view schematically showing the cooler. FIG. 6 is a cross-sectional view taken along a line VI-VI in FIG. 5. As shown in FIGS. 5 and 6, cooler 200 includes four cooling portions 210, a folded portion 220, and a coupling portion 230.

Each cooling portion 210 has a shape elongated in the first direction. Each cooling portion 210 cools one power storage stack. FIG. 5 shows two-dot chain lines indicating power storage stacks 11 to 14. As shown in FIG. 4, each cooling portion 210 is in thermal contact with valve installation surface 121 of each power storage cell 100. Each cooling portion 210 is in contact with valve installation surface 121 of each power storage cell 100 with a thermally conductive adhesive 910 being interposed therebetween. Thermally conductive adhesive 910 extends in the first direction. The state of being in thermal contact includes the state in which cooling portion 210 is in direct contact with valve installation surface 121 and the state in which cooling portion 210 is in indirect contact with valve installation surface 121 with a thermally conductive member (an adhesive, a fixing member, or the like) being interposed therebetween. Each cooling portion 210 may be formed by extrusion molding of metal such as aluminum. As shown in FIGS. 4 and 5, each cooling portion 210 includes an upstream flow path 211 and a downstream flow path 212.

Upstream flow path 211 is provided on the upstream side in the flow direction of the cooling medium. Downstream flow path 212 is provided on the downstream side in the flow direction of the cooling medium. As shown in FIG. 5, upstream flow path 211 and downstream flow path 212 each are shaped to extend in the first direction. Upstream flow path 211 and downstream flow path 212 are adjacent to each other in the second direction. The cooling medium flows through upstream flow path 211 from one side toward the other side in the first direction, and flows through downstream flow path 212 from the other side toward the one side in the first direction.

As shown in FIGS. 4 and 5, each cooling portion 210 is provided with a through hole h. Through hole h extends in the first direction. Through hole h is provided in cooling portion 210 and positioned to face safety valve SV of each power storage cell 100. The same number of through holes h as the number of power storage cells 100 in each power storage stack may be provided in cooling portion 210. Through hole h is provided in a portion of cooling portion 210 that is located between upstream flow path 211 and downstream flow path 212. In the present embodiment, through hole h is provided in a central portion of cooling portion 210 in the second direction.

Folded portion 220 couples a downstream end of upstream flow path 211 and an upstream end of downstream flow path 212. Thus, as indicated by arrows in FIG. 5, the cooling medium flows through upstream flow path 211, folded portion 220, and downstream flow path 212 in this order.

Coupling portion 230 couples four cooling portions 210 to each other. As shown in FIG. 6, coupling portion 230 includes a coupling portion main body 232 and a partition wall 234.

Coupling portion main body 232 couples four cooling portions 210 to each other. Thus, the cooling media having flowed through respective downstream flow paths 212 merge with each other inside coupling portion main body 232. Coupling portion main body 232 may be formed in a substantially rectangular parallelepiped shape.

Partition wall 234 partitions the inside of coupling portion main body 232 into two spaces. In the present embodiment, as shown in FIG. 6, partition wall 234 divides the inside of coupling portion main body 232 into two parts in the upward-downward direction. An upstream end of each upstream flow path 211 is connected to a space above partition wall 234 (the space will be hereinafter referred to as an “upstream space S11”) inside coupling portion main body 232, and a downstream end of each downstream flow path 212 is connected to a space below partition wall 234 (the space will be hereinafter referred to as a “downstream space S12”) inside coupling portion main body 232. Thus, the cooling medium having flowed into upstream space S11 flows into each upstream flow path 211. The cooling medium having flowed out of each downstream flow path 212 flows into downstream space S12.

As shown in FIGS. 5 and 6, an inflow portion 236 and an outflow portion 238 are connected to coupling portion 230.

Inflow portion 236 allows for communication between upstream space S11 inside coupling portion main body 232 and the outside of coupling portion main body 232. Thus, the cooling medium flows into upstream space S11 inside coupling portion main body 232 from the outside of coupling portion main body 232 through inflow portion 236. In the present embodiment, inflow portion 236 is connected to an upper surface of coupling portion main body 232.

Outflow portion 238 allows for communication between downstream space S12 inside coupling portion main body 232 and the outside of coupling portion main body 232. Thus, the cooling medium flows out of coupling portion main body 232 from downstream space S12 of coupling portion main body 232 through outflow portion 238. In the present embodiment, outflow portion 238 is connected to an upper portion of coupling portion main body 232 and partition wall 234. The cooling medium flowing out of coupling portion main body 232 through outflow portion 238 is higher in temperature than the cooling medium flowing into coupling portion main body 232 through inflow portion 236.

Housing 300 accommodates at least one power storage cell 100. In the present embodiment, housing 300 accommodates four power storage stacks 11 to 14 and cooler 200. As shown in FIG. 4, housing 300 includes a lower case 310, an upper cover 320, a panel member 330, a structural member 340, a spacer member 350, and fastening members B1 and B2.

Lower case 310 is opened upward. Lower case 310 has a bottom surface 312 and a peripheral wall 314.

Bottom surface 312 is located below each of power storage stacks 11 to 14. Bottom surface 312 may be formed in a flat plate shape.

Peripheral wall 314 rises from a peripheral edge portion of bottom surface 312. Peripheral wall 314 is shaped to surround lower portions of power storage stacks 11 to 14.

Together with lower case 310, upper cover 320 accommodates the plurality of power storage cells 100. In the present embodiment, together with lower case 310, upper cover 320 accommodates four power storage stacks 11 to 14 and cooler 200 in a hermetically sealed state. Upper cover 320 has an upper wall 322 formed above power storage stacks 11 to 14. Upper wall 322 may be provided with beads extending in the second direction. Upper cover 320 has a peripheral edge portion connected to a peripheral edge portion of lower case 310 with bolts or the like with a seal member being interposed therebetween.

Panel member 330 is provided below lower case 310. Panel member 330 is joined to a lower surface of bottom surface 312. Panel member 330 has a function of protecting lower case 310. Panel member 330 may be formed in a flat plate shape.

Structural member 340 is fixed to lower case 310. Structural member 340 is used to attach spacer member 350 to lower case 310. Structural member 340 includes a first base 340A and a second base 340B.

First base 340A is provided on one side of through hole h in the second direction. First base 340A is connected to an inner surface of lower case 310 by welding or the like. First base 340A includes a first seat portion 341. First seat portion 341 is formed substantially in parallel with bottom surface 312.

Second base 340B is provided on the other side of through hole h in the second direction. Second base 340B is connected to the inner surface of lower case 310 by welding or the like. Second base 340B includes a second seat portion 342. Second seat portion 342 is formed substantially in parallel with bottom surface 312.

As shown in FIG. 4, second base 340B includes a reinforcement portion 343. Reinforcement portion 343 reinforces lower case 310. Reinforcement portion 343 is contiguous to second seat portion 342. Reinforcement portion 343 is connected to a portion of bottom surface 312 of lower case 310 between a plurality of first power storage cells 101 (see FIG. 4) included in power storage stack 11 disposed on the outermost side in the second direction and a plurality of second power storage cells 102 (see FIG. 4) included in power storage stack 12 adjacent to power storage stack 11. Reinforcement portion 343 extends in the first direction. Reinforcement portion 343 is connected to peripheral wall 314. Reinforcement portion 343 may be connected to the pair of first frames 21 through brackets (not shown).

As shown in FIG. 4, reinforcement portion 343 includes a reinforcement portion main body 344 and a connection bottom surface 345.

Reinforcement portion main body 344 is shaped to protrude in a direction away from bottom surface 312 of lower case 310. Reinforcement portion main body 344 is disposed below external terminal 130 of power storage cell 100. Reinforcement portion main body 344 overlaps, in the upward-downward direction, with both the pair of external terminals 130 facing each other in the second direction.

Connection bottom surface 345 extends outward in the second direction from a lower end portion of reinforcement portion main body 344. Connection bottom surface 345 is connected to bottom surface 312 of lower case 310 by welding or the like. Connection bottom surface 345 couples reinforcement portion main body 344 and second seat portion 342. Connection bottom surface 345 is formed to be flat.

Spacer member 350 provides a space S (see FIGS. 3 and 4) together with bottom surface 312 of lower case 310. Spacer member 350 is fixed to structural member 340. Spacer member 350 is provided between bottom surface 312 of lower case 310 and at least one power storage cell 100. Specifically, spacer member 350 is provided between bottom surface 312 and each of power storage stacks 11 to 14. In other words, in the present embodiment, four spaces S are provided inside housing 300.

Each space S functions as a smoke discharge path (hereinafter referred to as a “smoke discharge path S”). Smoke discharge path S serves as a path through which the gas discharged from safety valve SV is discharged to the outside of housing 300. Each smoke discharge path S is connected to a common space inside housing 300 at an end portion of smoke discharge path S in the first direction.

Spacer member 350 has a through hole 354h provided below safety valve SV. When gas is discharged from safety valve SV of power storage cell 100, the gas flows into smoke discharge path S through the through hole 354h. In the present embodiment, through hole 354h is provided in a portion of spacer member 350 that faces each safety valve SV.

As shown in FIG. 3, an explosion-proof valve 390 is provided in a portion of peripheral wall 314 that faces smoke discharge path S in the first direction. Explosion-proof valve 390 is provided in a common space inside housing 300. Explosion-proof valve 390 releases the pressure inside housing 300. Explosion-proof valve 390 opens when the pressure inside housing 300 becomes equal to or higher than a reference value. Explosion-proof valve 390 is formed of a check valve. As shown in FIG. 3, when gas is discharged from one of power storage cells 100, the gas spreads in the first direction through smoke discharge path S and is discharged to the outside of housing 300 through explosion-proof valve 390.

As shown in FIG. 4, spacer member 350 includes a first mount portion 351, a second mount portion 352, a support portion 353, and a coupling portion 354.

First mount portion 351 is placed on first seat portion 341 of first base 340A. In other words, first seat portion 341 supports first mount portion 351. First mount portion 351 is formed to be flat.

Second mount portion 352 is placed on second seat portion 342 of second base 340B. In other words, second seat portion 342 supports second mount portion 352. Second mount portion 352 is formed to be flat.

As shown in FIG. 4, in the present embodiment, second base 340B further includes a first seat portion 341 that supports first mount portion 351 of spacer member 350 disposed below the plurality of power storage cells 102. First seat portion 341 is contiguous to reinforcement portion 343.

Support portion 353 protrudes from first mount portion 351 and second mount portion 352. Support portion 353 supports cooler 200. In other words, cooler 200 is disposed between the lower surface of cell case 120 and spacer member 350. Support portion 353 includes a first support portion 353a and a second support portion 353b.

First support portion 353a supports upstream flow path 211. More specifically, first support portion 353a supports upstream flow path 211 with an adhesive member 920 being interposed therebetween. First support portion 353a is formed in a flat plate shape.

Second support portion 353b supports downstream flow path 212. More specifically, second support portion 353b supports downstream flow path 212 with adhesive member 920 being interposed therebetween. Second support portion 353b is formed in a flat plate shape.

Coupling portion 354 couples first support portion 353a and second support portion 353b. In the present embodiment, coupling portion 354 protrudes from first support portion 353a and second support portion 353b. As shown in FIG. 4, coupling portion 354 is located inside through hole h of cooler 200. In other words, coupling portion 354 overlaps with upstream flow path 211 and downstream flow path 212 in the second direction. Through hole 354h is provided in a portion of coupling portion 354 that faces safety valve SV.

As shown in FIG. 4, a heat insulation plate 250 may be placed on coupling portion 354. Heat insulation plate 250 is provided between each through hole 354h of spacer member 350 and safety valve SV of power storage cell 100. Each heat insulation plate 250 is made, for example, of mica obtained by hardening a natural inorganic mineral through heat pressing. Each heat insulation plate 250 is shaped to cover through hole 354h. A notch may be provided in a portion of each heat insulation plate 250 that overlaps with an edge portion of through hole 354h.

As shown in FIG. 4, a protective plate 380 may be disposed on bottom surface 312 of lower case 310. Protective plate 380 receives a blast discharged from safety valve SV. Protective plate 380 is disposed on a portion of bottom surface 312 that is located below through hole 354h of spacer member 350. Protective plate 380 is made of a heat insulation member (for example, mica obtained by hardening a natural inorganic mineral through heat pressing).

Fastening members B1 and B2 fasten spacer member 350 to structural member 340. In the present embodiment, fastening members B1 and B2 include a first fastening portion B1 and a second fastening portion B2.

First fastening portion B1 fastens first mount portion 351 to first seat portion 341 of first base 340A. Examples of first fastening portion B1 include a bolt. First fastening portion B1 may be connected to first seat portion 341 by welding or the like. First mount portion 351 is fastened to first seat portion 341 with first fastening portion B1 and a nut N1.

Second fastening portion B2 fastens second mount portion 352 to second seat portion 342 of second base 340B. Examples of second fastening portion B2 include a bolt. Second fastening portion B2 may be connected to second seat portion 342 by welding or the like. Second mount portion 352 is fastened to second seat portion 342 with second fastening portion B2 and a nut N2.

As shown in FIGS. 3 and 4, reinforcement member 620 is disposed on upper cover 320. More specifically, reinforcement member 620 is placed on upper wall 322. Reinforcement member 620 has a function of dispersing a load that locally acts on power storage device 10 from above by an occupant of vehicle 1.

Device unit 800 is disposed, for example, at an end portion in the first direction. In the present embodiment, device unit 800 is disposed on a rear portion of upper cover 320 in the front-rear direction of vehicle 1. Device unit 800 includes a junction box 812, an electricity supply unit 814, an electronic control unit 816, a first cooler 822, a second cooler 824, and a device cover 830.

Junction box 812 is disposed above upper cover 320. Junction box 812 accommodates relays, fuses, and the like. Junction box 812 is cooled by first cooler 822 disposed between junction box 812 and upper cover 320.

Electricity supply unit 814 is disposed above junction box 812. Electricity supply unit 814 is cooled by second cooler 824 disposed on electricity supply unit 814.

Electronic control unit 816 is disposed above junction box 812.

Device cover 830 accommodates junction box 812, electricity supply unit 814, electronic control unit 816, and second cooler 824.

In power storage device 10 described above, when gas is discharged downward from safety valve SV due to a short circuit or the like in any one of power storage cells 100, the gas breaks heat insulation plate 250 and flows into smoke discharge path S through the through hole 354h. Thus, the contents (what is called debris) of power storage cell 100 that are contained in the gas are suppressed from adhering to external terminal 130 and the like of power storage cell 100.

Further, valve installation surface 121 of power storage cell 100 is cooled by cooler 200, which suppresses breakage of valve installation surface 121 occurring when the gas flows out from safety valve SV.

The gas having flowed into smoke discharge path S spreads in the first direction and then is discharged from housing 300 through explosion-proof valve 390 as shown in FIG. 3. In this case, heat insulation plate 250 closes each through hole 354h positioned to face safety valve SV of each of other power storage cells 100 different from power storage cell 100 from which the gas has been discharged. Thereby, the gas spreading through smoke discharge path S is suppressed from coming into contact with valve installation surface 121 of each of these other power storage cells 100. Therefore, each power storage cell 100 other than power storage cell 100 from which gas has been discharged is suppressed from being heated by the gas.

Further, heat insulation plate 250 is placed on coupling portion 354 protruding from first support portion 353a and second support portion 353b, so that the distance between safety valve SV and heat insulation plate 250 is reduced. Therefore, the blast discharged from safety valve SV in one power storage cell 100 is suppressed from being bounced back by heat insulation plate 250 and thereby heading toward safety valve SV in power storage cell 100 adjacent to this one power storage cell 100.

Further, spacer member 350 is fastened to structural member 340 by fastening members B1 and B2. Thus, for example, in the case where panel member 330 is damaged by an external force applied to power storage device 10 from below, breaking a seal member between lower case 310 and upper cover 320 and also detaching fastening portions B1 and B2 make it possible to replace the unit (the bottom portion of power storage device 10) constituted of lower case 310, panel member 330, and structural member 340.

The following describes a modification of the above-described embodiment.

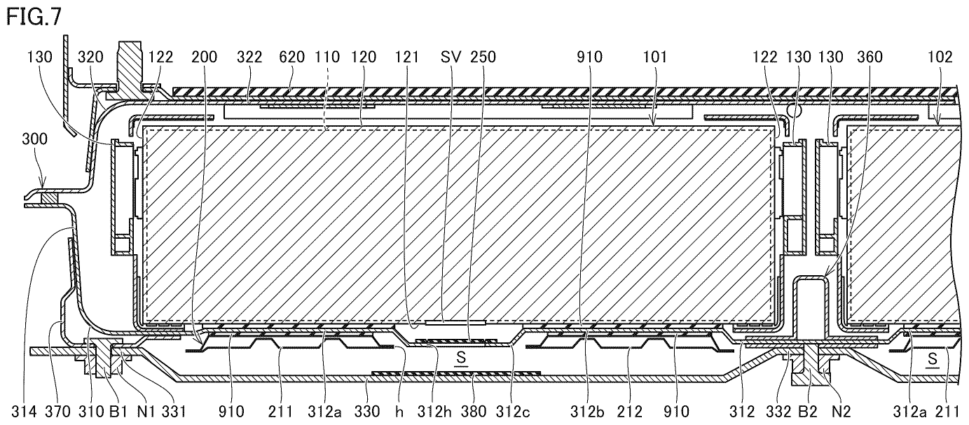

As shown in FIG. 7, space S may be provided between bottom surface 312 of lower case 310 and panel member 330, and cooler 200 may be disposed inside space S. In the present example, panel member 330 provides space S together with bottom surface 312, and spacer member 350 in the above-described embodiment is not provided.

Bottom surface 312 of lower case 310 has a first bottom surface 312a, a second bottom surface 312b, and an intermediate bottom surface 312c.

First bottom surface 312a is connected to upstream flow path 211 with thermally conductive adhesive 910 being interposed therebetween. First bottom surface 312a is connected to valve installation surface 121 of power storage cell 100 with thermally conductive adhesive 910 being interposed therebetween. In other words, power storage cell 100 is in thermal contact with upstream flow path 211 with thermally conductive adhesive 910 being interposed therebetween. First bottom surface 312a is formed to be flat.

Second bottom surface 312b is connected to downstream flow path 212 with thermally conductive adhesive 910 being interposed therebetween. Second bottom surface 312b is connected to valve installation surface 121 of power storage cell 100 with thermally conductive adhesive 910 being interposed therebetween. In other words, power storage cell 100 is in thermal contact with downstream flow path 212 with thermally conductive adhesive 910 being interposed therebetween. Second bottom surface 312b is formed to be flat.

Intermediate bottom surface 312c couples first bottom surface 312a and second bottom surface 312b. An opening 312h is provided in a portion of intermediate bottom surface 312c that faces safety valve SV. Heat insulation plate 250 is placed on intermediate bottom surface 312c so as to close opening 312h.

In the present example, a cross member 360 is connected to bottom surface 312 of lower case 310. Cross member 360 is connected by welding or the like to a portion of bottom surface 312 that is located between a pair of power storage stacks adjacent to each other. Cross member 360 has the same structure as that of reinforcement portion 343 in the above-described embodiment.

Panel member 330 is fastened to bottom surface 312 of lower case 310 by fastening members B1 and B2. Specifically, panel member 330 includes a first sandwiched portion 331 and a second sandwiched portion 332.

First sandwiched portion 331 is sandwiched between first fastening portion B1 and nut N1. First fastening portion B1 is fixed to a bracket 370 connected by welding or the like to lower case 310. First fastening portion B1 may be welded to bracket 370.

Second sandwiched portion 332 is sandwiched between nut N2 and a portion of bottom surface 312 of lower case 310 that is located between first power storage cell 101 and second power storage cell 102. Nut N2 is connected to a lower surface of second sandwiched portion 332 by welding or the like. Second fastening portion B2 is screwed into nut N2, and thereby, second sandwiched portion 332 is sandwiched.

In power storage device 10 in the present example, panel member 330 is fastened to lower case 310 by fastening members B1 and B2. Thus, by detaching fastening members B1 and B2, panel member 330 forming the bottom portion of power storage device 10 can be detached from lower case 310.

It will be understood by those skilled in the art that the above-described exemplary embodiment is a specific example of the following aspects.

### Aspect 1

A power storage device including:
at least one power storage cell having a lower surface provided with a safety valve;
a lower case having a bottom surface located below the at least one power storage cell;
a structural member fixed to the lower case;
a spacer member fixed to the structural member to provide a space together with the bottom surface of the lower case; and
a fastening member that fastens the spacer member to the structural member, wherein
the spacer member has a through hole provided below the safety valve.

In the present power storage device, the spacer member is fastened to the structural member by the fastening member. Thus, by detaching the fastening member, the lower case forming the bottom portion of the power storage device can be detached from the spacer member together with the structural member.

### Aspect 2

The power storage device according to Aspect 1, wherein
the at least one power storage cell includes a plurality of power storage cells arranged side by side in a first direction,
the structural member includes
   a first base provided on one side of the through hole in a second direction orthogonal to both the first direction and an upward-downward direction, and
   a second base provided on the other side of the through hole in the second direction,
the spacer member includes
   a first mount portion placed on the first base, and
   a second mount portion placed on the second base, and
the fastening member includes
   a first fastening portion that fastens the first mount portion to the first base, and
   a second fastening portion that fastens the second mount portion to the second base.

### Aspect 3

The power storage device according to Aspect 2, wherein
the plurality of power storage cells include
   a plurality of first power storage cells arranged side by side in the first direction, and
   a plurality of second power storage cells disposed to face the plurality of first power storage cells in the second direction and arranged side by side in the first direction,
the first base includes a first seat portion that supports the first mount portion,
the second base includes
   a second seat portion that supports the second mount portion, and
   a reinforcement portion contiguous to the second seat portion to reinforce the lower case, and
the reinforcement portion is connected to a portion of the bottom surface of the lower case, the portion of the bottom surface being located between the plurality of first power storage cells and the plurality of second power storage cells, and the reinforcement portion extends in the first direction.

In the present aspect, since the second base includes the reinforcement portion, the number of components is reduced as compared with the case where a dedicated reinforcement member for reinforcing the lower case is provided.

### Aspect 4

A power storage device including:
at least one power storage cell having a lower surface provided with a safety valve;
a lower case having a bottom surface located below the at least one power storage cell;
a panel member provided below the bottom surface of the lower case, a space being provided between the panel member and the bottom surface of the lower case; and
a fastening member that fastens the panel member to the lower case, wherein
the bottom surface of the lower case has an opening provided below the safety valve.

In the present power storage device, the panel member is fastened to the lower case by the fastening member. Thus, by detaching the fastening member, the panel member forming the bottom portion of the power storage device can be detached from the lower case.

### Aspect 5

The power storage device according to Aspect 4, further including a cooler that cools the at least one power storage cell, the cooler being disposed in the space, wherein
the cooler is in thermal contact with the lower surface of the at least one power storage cell with at least the bottom surface of the lower case being interposed therebetween.

### Aspect 6

The power storage device according to Aspect 1, further including a protective plate disposed on a portion of the bottom surface of the lower case, the portion of the bottom surface being located below the through hole of the spacer member, wherein
the protective plate is formed of a heat insulation member.

Although the embodiment of the present disclosure has been described, it should be understood that the embodiment disclosed herein is illustrative and non-restrictive in every respect. The scope of the present disclosure is defined by the terms of the claims, and is intended to include any modifications within the meaning and scope equivalent to the terms of the claims.

What is claimed is:

1. A power storage device comprising:
at least one power storage cell having a lower surface provided with a safety valve;
a lower case having a bottom surface located below the at least one power storage cell;
a structural member fixed to the lower case;
a spacer member fixed to the structural member to provide a space together with the bottom surface of the lower case; and
a fastening member that fastens the spacer member to the structural member, wherein
the spacer member has a through hole provided below the safety valve.

2. The power storage device according to claim 1, wherein
the at least one power storage cell includes a plurality of power storage cells arranged side by side in a first direction,
the structural member includes
a first base provided on one side of the through hole in a second direction orthogonal to both the first direction and an upward-downward direction, and
a second base provided on the other side of the through hole in the second direction,
the spacer member includes
a first mount portion placed on the first base, and
a second mount portion placed on the second base, and
the fastening member includes
a first fastening portion that fastens the first mount portion to the first base, and
a second fastening portion that fastens the second mount portion to the second base.

3. The power storage device according to claim 2, wherein
the plurality of power storage cells include
a plurality of first power storage cells arranged side by side in the first direction, and
a plurality of second power storage cells disposed to face the plurality of first power storage cells in the second direction and arranged side by side in the first direction,
the first base includes a first seat portion that supports the first mount portion,
the second base includes
a second seat portion that supports the second mount portion, and
a reinforcement portion contiguous to the second seat portion to reinforce the lower case, and
the reinforcement portion is connected to a portion of the bottom surface of the lower case, the portion of the bottom surface being located between the plurality of first power storage cells and the plurality of second power storage cells, and the reinforcement portion extends in the first direction.

4. A power storage device comprising:
at least one power storage cell having a lower surface provided with a safety valve;
a lower case having a bottom surface located below the at least one power storage cell;
a panel member provided below the bottom surface of the lower case, a space being provided between the panel member and the bottom surface of the lower case; and
a fastening member that fastens the panel member to the lower case, wherein
the bottom surface of the lower case has an opening provided below the safety valve.

5. The power storage device according to claim 4, further comprising a cooler that cools the at least one power storage cell, the cooler being disposed in the space, wherein
the cooler is in thermal contact with the lower surface of the at least one power storage cell with at least the bottom surface of the lower case being interposed therebetween.

6. The power storage device according to claim 1, further comprising a protective plate disposed on a portion of the bottom surface of the lower case, the portion of the bottom surface being located below the through hole of the spacer member, wherein
the protective plate is formed of a heat insulation member.
